(19) United States
(12) Patent Application Publication
(10) Pub. No.: US 2008/0118856 A1
(43) Pub. Date: May 22, 2008

(54) Marking Liquid

(76) Inventor: Olga Ivanova, South Australia (AU)

Correspondence Address: KLAUBER & JACKSON, 411 HACKENSACK AVENUE, HACKENSACK, NJ, 07601, US

(21) Appl. No.: 11/792,570

(22) PCT Filed: Dec. 14, 2005
(86) PCT No.: PCT/AU05/01884

§ 371 Date: Jun. 6, 2007

(30) Foreign Application Priority Data
Dec. 20, 2004 (AU) 2004907181

(51) Int. Cl. G03G 9/12

(52) U.S. Cl. 430/113

(57) ABSTRACT

A liquid toner or developer for electrostatic images comprises a carrier liquid, insoluble marking particles and a dispersing agent. The dispersing agent is non-compatible with or insoluble in the carrier liquid. The liquid toner or developer does not need the use of a corona generating wire, roller or the like, to adjust or change the orientation of individual toner particles within the toner deposit prior to the development of the latent electrostatic image. For instance the liquid toner or developer is a three phase colloid system comprising a carrier liquid phase, a marking particle phase and a dispersing agent. The marking particles are insoluble in the carrier liquid and the dispersing agent phase. The dispersing agent comprising droplets which are non-compatible with or insoluble in the carrier liquid.

### FIELD OF THE INVENTION

This invention relates to a method of preparation of marking liquids for use in non-impact electrostatic printers.

### BACKGROUND OF THE INVENTION

A non-impact printing process can be simply defined as a process which uses an electronic, electric, or optical means to produce characters as opposed to a mechanical means. Of the non-impact printing processes, there is a group of printing methods that uses electrostatic techniques. Electrostatic printing can be defined as those methods which use the interaction of electrostatically charged marking particles and an electric field to control the deposition of the marking particles onto a substrate, and encompasses processes generally known as electrographic, electrophotographic, or electrostatographic printing.

Electrostatography can be a term used to describe the various non-impact printing processes which involve the creation of a visible image by the attraction of charged imaging particles or marking particles to charged sites present on a substrate. Such charged sites, forming what is usually termed an electrostatic latent image, can be transiently supported on photoconductors or pure dielectrics and may be rendered visible in situ or be transferred to another substrate to be developed in that location. Additionally such charged sites may be the reflection of those structured charges existing within a permanently polarised material as in the case with ferroelectrics or other electrets.

In electrostatography the imaging particles, generally Inown as toner, can be of the dry type or of the liquid type. Dry powder toners have many disadvantages. For example the performance of dry powder toners is very susceptible to environmental conditions, influencing, for example, charge stability, and therefore giving rise to variable image performance. Also, the large particle size of dry powder toners is a major contributing factor in not allowing the achievement of highly resolved developed images.

Achieving highly resolved images with dry powder toners necessitates further reduction in dry toner particle size to a level which will allow acceptable resolution. However, sufficiently small particles of dry toner are prone to escape from the developer, and these deposit onto any surface both within and outside the printing device, causing mechanical failures within the device and envirornental problems outside the device. This problem usually known as dusting becomes severe when such dry powder printing devices are run at high speed. Dry powder system therefore can not in practice achieve high resolution images, particularly at high speeds, that are usually associated with analog printing methods such as off-set and gravure printing. Other disadvantages include cost of the general maintenance of the printer and cost of the dry powder toner.

It is known that latent electrostatic images can be developed with marking particles dispersed in insulating or non-polar liquids. These dispersed materials are known as liquid toners or liquid developers. Such marking particles normally comprise colouring matter such as pigments which have been ground with or otherwise combined with dispersing resins or varnishes or the like. Additionally, charge directing agents are usually included to control the polarity and charge to mass ratio of the toner particles. These dispersed materials are known as liquid toners or liquid developers. In use, a liquid developer is applied to the surface of a latent image bearing member to develop an electrostatic image on the member.

In general, the process of production of electrostatic marking liquids commences with a resin or a resin system which can contain a resin or a combination of resins and which may also contain a colourant, which can be ground, extruded from a suitable mixing machine or otherwise combined by other techniques known to the art, including means of producing a masterbatch such as for example a twin roll mill. Additionally included in the resin system there can be added dispersing resins, plasticisers or varnishes, as is generally known in the art.

The colourant can be a dye which is soluble in the resin or a pigment comprising of colourant particles which are not soluble in the resin. The resin system and colourant are then milled in a carrier liquid in which neither the resin nor the colourant is soluble, to produce a marking liquid with very fine marking particles distributed in it.

Additionally, charge directing agents are usually included in the marking liquids to control the polarity and charge to mass ratio of the toner particles.

Liquid developers have generally utilized low viscosity liquids and low concentration of the solids content, that is, of marking particles. These traditional toners and associated process systems may be termed low viscosity toner or LVT systems. Generally, LVT systems utilise toners with low viscosities, typically 1 to 3 mPa·s. and low volumes of solids, typically 0.5 to 2% by weight. Maintaining a uniform dispersion of the marking particles can be difficult in a low viscosity toner system. The marking particles have a tendency to drift and settle in the carrier liquid. Furthermore, low volume of solids in the toner increases the amount of toner required to develop a given latent image. More toner will have to be transferred to the photoconductor in order to provide sufficient marking particles for a desired image density. Low viscosity liquids usually have a high degree of volatility, hence, the LVT printing systems based on these materials can create significant environmental concerns, especially, when used in the office.

To overcome these and other known problems that can be associated with LVT systems, highly concentrated liquid toner development systems utilising toner with solids concentrations of up to 60% by weight and viscosities of up to 10,000 mPa·s, and utilizing thin films, typically 1 to 40 μm, of the highly concentrated and viscous liquid toner have been disclosed. This system of developing electrostatic latent images with these viscous and highly concentrated liquid toner systems may be termed high viscosity toner or HVT systems. An Example of such liquid toners is disclosed in commonly assigned U.S. Pat. No. 5,612,162 to Lawson et al., the disclosure of which is totally incorporated herein by reference. Examples of high viscosity, high concentration liquid developing methods and apparatus are disclosed in commonly assigned U.S. Pat. No. 6,137,976 to Itaya et al. and U.S. Pat. No. 6,167,225 to Sasaki et al., the disclosures of which are totally incorporated herein by reference. These new HVT liquid developing systems overcome many of the short-comings of traditional LVT systems.

It would be understood by those skilled in the art of liquid electrography that many of the processes and techniques utilised in the development of latent images in LVT systems can also be applicable to HVT systems.

U.S. Pat. No. 4,021,586 to Matkan, the disclosure of which is totally incorporated herein by reference, discloses one such process technique in which a corona generating wire or roller or the like is placed in a position adjacent to a liquid toner layer transport means, and a corona producing voltage is applied which may be used to reinforce the charge on the individual toner particles or change their orientation within the toner deposit. Such toner material when presented to the latent image allows for the development of images to extremely uniform density and devoid of background stain.

Such a prior art technique has been commonly used to change the orientation of toner particles within the toner layer in HVT systems. The application of such a voltage assists in producing an evenly orientated and continuous toner layer which translates to high development efficiency and therefore the achievement of superior image quality.

It is the object of thus invention to provide a liquid electrostatographic toner which facilitates the formation of an evenly orientated and continuous toner layer which allows high development efficiency and superior image quality without the need for the use of a corona generating wire, roller or the like, or the requirement for any other like means for the facilitation of an evenly oriented and continuous toner layer.

### DESCRIPTION OF THE INVENTION

The applicant has surprisingly found that liquid developers that use a carrier fluid, marking particles, and a dispersant that is non-compatible with or non-soluble in the carrier fluid allow for the formation of an evenly charged and orientated continuous toner layer for high development efficiency and superior image quality without the need for the use of a corona generating wire, roller or the like, to change the orientation of toner particles within the toner deposit prior to the development of the latent electrostatic image, as commonly used in the art.

The term “non-compatible with” in this specification is intended to mean a compound which is insoluble if it is a solid or immiscible if it is a liquid with the carrier fluid.

In one form therefore, although this may not necessarily be the only or broadest form, the invention is said to reside in a liquid electrographic toner or developer, the developer comprising a carrier liquid, insoluble marking particles and a dispersing agent, characterised by the dispersing agent being non-compatible in the carrier liquid.

In an alternative form the invention is said to reside in a liquid electrographic toner or developer, including a carrier liquid, insoluble marking particles and a dispersing agent wherein the dispersing agent comprises a liquid which is immiscible in the carrier liquid.

In an alternative form the invention is said to reside in a liquid electrographic toner or developer, including a carrier liquid, insoluble marking particles and a dispersing agent wherein the dispersing agent comprises a solid which is insoluble in the carrier liquid.

In an alternative form the invention is said to reside in a liquid toner or developer for electrostatic images comprising a three phase colloid system comprising a carrier liquid phase, a marking particle phase wherein the marking particles are insoluble in the carrier liquid and a dispersing agent phase, characterised by the dispersing agent comprising droplets which are non-compatible with the carrier liquid.

In general, a liquid developer or toner for electrostatography is prepared by dispersing an inorganic or organic colourant in a carrier liquid. The liquid developer should be stable, not only in terms of suspension stability, but also of electrical charge. Additional components can be integrated into the developer to achieve liquid developers that exhibit reproducible high quality images.

In such developers, it has been recognised that certain properties of the carrier liquid are mandatory requirements for the effective functioning of a conventional electrostatographic liquid development process. The mandatory requirements include low electrical conductivity but other requirements have also become obvious, such as the need for low toxicity, increased fire safety, low solvent power, low odour etc. For these reasons, isoparaffinic-hydrocarbons such as the Isopar® range manufactured by Exxon Mobil, the Shellsol® range manufactured by Shell Chemical and the Soltrol® range manufactured by Chevron Phillips Chemical Company have become the industry standards for liquid toner carriers.

Other carrier liquids may be used, and these may also comprise a silicone fluid of straight chained configuration, a silicone fluid of cyclic configuration, a silicone fluid of branched configuration, or a combination thereof.

The carrier liquid may also comprise a vegetable oil. Representative examples of vegetable oils include soybean oil, cottonseed oil, safflower oil, sunflower oil, castor oil, linseed oil and olive oil.

The carrier liquid may also comprise a synthetic oil. Representative examples of synthetic oils include fatty acid esters obtained by the reaction between higher fatty acid and alcohol, and ester compounds obtained by the reaction between higher fatty acid and ethylene glycol or glycerine.

The carrier liquid may also comprise a mineral oil or white oil.

It would be understood by those skilled in the art that blends or other suitable carrier liquids could be used in relation to this invention.

The marking particles may comprise a colourant and an optional resin or resin system to act as a binder in the finished deposited image.

Colourants that are insoluble in the carrier liquid may be selected upon their particular proposed end use. Examples of marking particles include inorganic pigments such as iron oxide, silica, alumina, titanium dioxide, magnetic iron oxide, or organic pigments such as carbon black, phthalocyanine blue, alkali and reflex blue, phthalocyanine green, diarylide yellow, arylamide yellow, azo and diazo yellow, azo red, rubine toner, quinacridone red, basic dye complexes, lake red, or fluorescent pigments and dyestuffs such as basic dyes and spirit soluble dyes, or combinations thereof. Other materials, as would be understood by those skilled in the art, could be used as colourants, or marking particles.

As indicated above, the liquid developer or toner may include an organic or inorganic insoluble marking particle and such a marking particle may be present in the range of 1 to 60% by weight of the finished toner.

The resin or combination of resins to make up the resin system may be selected from one or more of ethyl cellulose, oil modified alkyd resin, acrylic or methacrylic ester resin, polystyrene, silicone-acryl copolymer, silicone resin, silicone-(meth)acryl copolymer, block polymer or graft polymer, polyolefin copolymer, poly(vinyl chloride) resin, chlorinated polypropylene, polyamide resin, coumarone-indene resin, rosin-modified resin, and alkylphenol-modified xylene resin, synthetic polyesters; polypropylene or modified polypropylene; alkylated poly vinyl pyrrolidones; natural waxes such as montan wax, candelilla wax, sugar cane wax, beeswax, natural resins such as ester gum and hardened rosin; natural-resin-modified cured resins such as natural resin-modified maleic acid resins, natural resin-modified phenol resins, natural resin-modified polyester resins, natural resin-modified pentaerythritol resins, styrene acrylates and epoxy resins.

Other components such as plasticisers can also be incorporated, examples of which are sulfonamides, adipates, sebacates and phthalates.

Additionally to affect or enhance electrostatic charge on such dispersed particles additives known as charge directors or charge control agents may be included. Such materials can be metallic soaps, fatty acids, lecithin, organic phosphorus compounds, succinimides and sulphosuccinates, as is known in the art.

The charge control agent may be present in a range of 0.01 to 5% by weight of the toner when used.

The use of dispersants has been disclosed but in the prior art dispersants have been selected for their compatibility with the carrier liquid of the toner system. For example U.S. Pat. No. 6,287,741 to Marko.

The Applicant has surprisingly found that liquid toners manufactured with non-compatible dispersing agents, that is, dispersants which are non-soluble or immiscible in the carrier fluid, allow for the formation of an evenly charged and orientated continuous toner layer on a development member for high development efficiency and superior image quality without the need for the use of a corona generating wire, roller or the like, to change the orientation of the individual toner particles within the toner deposit prior to the development of the latent electrostatic image.

Dispersing agents can include and may be selected for example, from the group of amino-silicones including Finish WT 1250, Finish WR1600, Finish WR1300, Finish WR1100, and Fluid L656 manufactured by Wacker Chemicals; from the group of polymeric dispersants including Solsperse 17000, Solsperse 21000 and Solsperse 13940 manufactured by Avecia; from the group of polymeric oil additives including Plexol 954 manufactured by Rohm and Hass; from the group of polyolefins including Solprene 201 and Solprene 1205 manufactured by Phillips Petroleum; from the group of fluorinated surfactants including Fluorad FC-740 manufactured by 3M. The dispersant chosen being dependent on the carrier liquid to be used in a particular liquid developer or toner.

For instance with silicone fluid carrier liquids the following non-compatible dispersing agents could be used: Solsperse 17000, Solsperse 13940, Plexol 954, Solprene 201, Solprene 1205, Solsperse 21000 and Fluorad FC-740.

With hydrocarbon based carrier liquids, the following non-compatible dispersing agents could be used: Finish WT 1250, Finish WR1600, Finish WR1300, Finish WR1100 and Fluid L656.

Where the carrier liquid comprises a light paraffin oil the non-compatible dispersing agent may be selected from the group comprising amino-silicones, Finish WT 1250, Finish WR1600, Finish L656, Finish WR1300, Finish WR1100 and Fluid L656.

The non-compatible dispersing agent can be incorporated into the liquid composition by techniques commonly employed in the manufacture of liquid compositions such as ball-jar milling, attritor milling, bead milling etc. Pre-mixing techniques involving blending the dispersion agent into the carrier liquid before the addition of marking particles and before the milling stage can also be used to incorporate the non-compatible dispersion agent into the liquid developer formulation.

The noncompatible dispersion agent may be present in a range of 0.1 to 30% by weight of the toner when used.

Although the exact process by which these desired characteristics of a liquid toner are achieved is not fully understood, the following explanation will be given but the Applicant is not bound to this explanation.

The process of image development can be considered a multi-step process of the separation of toner particles from the liquid carrier. Conventional LVT systems which contain charged particles and soluble dispersing agents are stabilized by forces of both steric and electrostatic repulsion. They are generally stable colloids with therefore a long shelf-life. It is generally necessary to apply sufficient energy to overcome the repulsion forces between the toner particles during the process of image development.

However, it has been found that prior art toners in the HVT system may advantageously use a corona generating wire, roller or the like to change the orientation of individual toner particles within the toner deposit, and thus form a compacted liquid toner layer on the development member prior to image development. Any charge variation between toner particles existing in prior art toners that may have influence on the image development process, is significantly reduced in the compacted liquid toner layer, as it is the average charge of the whole layer that determines the particle deposition process during image development.

The word “orientation” in this specification is intend to mean a change to the orientation or spacial distribution of individual toner particles within a toner layer.

The Applicant has found that it is possible to avoid the need for the application of strong electric fields to the liquid toner layer prior to development by the preparation of a metastable toner, that is, a toner which is stable to aggregation and thus achieving long shelf-life, but unstable to flocculation at certain distances of particle separation. The potential energy curve of such toners has a secondary minimum, which corresponds to a flocculated state of dispersion, in which particles are bound together by weak forces. There is no reduction in the surface area of the particles in the flocculated state, but the particles lose their kinetic independence and move as one body. Therefore, there is no need for the application of strong electric fields to the liquid toner layer prior to development, to achieve an evenly orientated and continuous toner layer which translates to high development efficiency and therefore the achievement of superior image quality.

Particle orientation and/or separation from the liquid carrier can be achieved simply by the energy introduced into the toner layer by the electric field in the development area or nip. The process of particle orientation and or compaction occurs in the nip between the development member and the member on which the latent image is supported. Such a development process obviates the need for the additional step prior to developing the latent image, of changing the orientation of individual toner particles within the toner deposit, thus simplifying the development process.

If liquid toners are stabilised with dispersants that are non-soluble or not compatible with the liquid carrier, the non-soluble dispersants exist in the liquid carrier either in the form of a separate layer or in the form of droplets after prolonged shaking or milling. If these droplets remain unstabilised they will eventually form a separate layer. If the liquid carrier with a non-soluble dispersant is milled along with marking particles, it is possible to prepare a dispersion stable to aggregation. Such a dispersion is a three phase colloid: solid marking particles, liquid carrier and micro droplets of dispersing agent insoluble in the liquid carrier. In contrast, traditional LVT system toners are two phase colloids: solid marking particles and liquid carrier. HVT systems with soluble dispersing agents may also be considered as a two phase colloid: solid marking particles and liquid carrier.

The dispersing agents also tend to adsorb onto the surface of the particles; firstly because they are insoluble in the liquid carrier and therefore move away from the incompatible liquid; and secondly, because of the active functional groups of the dispersant which promote adsorption of dispersant onto the particle surface. The microdroplets in the liquid toners of the present invention, contribute to the long term toner stability.

When such liquid toners are placed in an external electric field, the micro droplets are capable of moving away from the marking particles due to their much smaller particle size and higher mobility. The movement of such micro-droplets away from the marking particles, results in the marking particles being brought together or flocculating, and thus forming an evenly orientated and continuous toner layer, and that has improved uniformity of the toner layer charge.

The liquid toners prepared according to this present invention exhibit improved print performance. Liquid toners prepared according to the present invention also show substantially increased optical density, decreased background fog or staining, and higher image resolution, without the need for the use of a corona generating wire, roller or the like, to change the orientation of individual toner particles within the toner deposit prior to the development of the latent electrostatic image.

This then generally describes the invention but to assist with understanding, reference will now be made to the accompanying comparison and non-limiting example which shows an embodiment of the invention.

### COMPARISON AND EXAMPLES

An extrudate was prepared with the following composition:

| | |
|---|---|
| Epikote 1001 | 49.4 g |
| Corflex DIDP | 4 g |
| Araldite GY280 | 26.6 g |
| Irgalite Blue LGLD | 20 g |

The above components were blended together to form the extrudate using, for example, a hot-melt extruder and allowed to cool. The extrudate was then crushed to a coarse powder, ready for use in the examples.

Epikote 1001 is an epoxy resin made by Shell Chemicals, Australia. Corflex DIDP is a plasticiser made by CSR Chemicals, USA. Araldite GY280 is an epoxy resin made by Ciba-Geigy, Switzerland. Irgalite Blue LGLD is a CI Pigment Blue 15:3 made by Ciba-Geigy, Switzerland.

### Comparison 1

A marking liquid of the following composition was then prepared using the extrudate:

| | |
|---|---|
| Extrudate | 100 g |
| Solsperse 13940 | 20 g |
| Light Paraffin Oil | 380 g |

Solsperse 13940 is a compatible dispersant in Light Paraffin Oil. Solsperse 13940 is a liquid polymeric dispersant (40% active dispersant in aliphatic distillate) soluble in Light Paraffin Oil made by Avecia, United Kingdom. Light Paraffin Oil is a 14-18 mPa·s (at 40° C.) mineral oil made by BP, Australia.

The so produced marking liquid of the above example was prepared by adding the constituents into a ceramic ball jar containing spherical ceramic grinding media and milling for 4 days to prepare a resinous toner.

### Example 1

The above Extrudate was also used to produce a marking liquid of the following composition:

| | |
|---|---|
| Extrudate | 100 g |
| Finish WT1250 | 15 g |
| Light Paraffin Oil | 385 g |

Finish WT1250 is a non-compatible dispersant in Light Paraffin Oil. Finish WT1250 is a liquid polysiloxane insoluble in Light Paraffin Oil having amine functional groups, made by Wacker Chemicals, Germany.

The so produced marking liquid of the above example was prepared by adding the constituents into a ceramic ball jar containing spherical ceramic grinding media and milling for 4 days to prepare a resinous liquid toner.

### Example 2

The above Extrudate was also used to produce a marking liquid of the following composition:

| | |
|---|---|
| Extrudate | 100 g |
| Solsperse 13940 | 15 g |
| DC 200 Fluid 50 cSt | 385 g |

Solsperse is a non-compatible dispersant in DC 200 Fluid 50 cSt. Solsperse 13940 is a liquid polymeric dispersant insoluble in DC 200 Fluid 50 cSt, made by Avecia, United Kingdom. DC 200 Fluid 50 cSt is a silicone fluid made by Dow Corning, USA.

The so produced marking liquid of the above example was prepared by adding the constituents into a ceramic ball jar containing spherical ceramic grinding media and milling for 4 days to prepare a resinous liquid toner.

### Example 3

The above Extrudate was also used to produce a marking liquid of the following composition:

| | |
|---|---|
| Extrudate | 100 g |
| Solsperse 17000 | 15 g |
| DC 200 Fluid 50 cSt | 385 g |

Solsperse 17000 is a non-compatible dispersant in DC 200 Fluid 50 cSt. Solsperse 17000 is a waxy solid polymeric dispersant insoluble in DC 200 Fluid 50 cSt, made by Avecia, United Kingdom.

The so produced marking liquid of the above example was prepared by adding the constituents into a ceramic ball jar containing spherical ceramic grinding media and milling for 4 days to prepare a resinous liquid toner.

It should be understood that the quantities of raw materials in the Examples can be varied dependent on the liquid developer or ink characteristics required and the mode of operation of the electrostatic printer.

### Physical Properties

### Dispersion Stability

The Comparison and Examples were tested for dispersion stability by assessment of agglomeration and sedimentation over a specified time period. Sedimentation was assessed by samples being placed in a volumetrically graduated sedimentation flask and the percent of sedimentation analysed after a defined time period; the amount of increase in the interface between the particles and the carrier represents the separated (sedimented) solids. Agglomeration was assessed by samples being placed in a beaker for a specified period of time and then assessed by stirring samples gently. The agglomeration level can be determined by the sample's resistance to stirring.

It was found that over a 6 month storage period, dispersion stability of the marking liquids with non-compatible dispersants have comparable stability, as can be seen in the following results:

| | Comparison | Example 1 | Example 2 | Example 3 |
|---|---|---|---|---|
| Sedimentation | <3% | <4% | <2% | <3% |
| Agglomeration | none | none | none | none |

### Print Testing

The samples were tested for image optical density (ODU) and background fog or staining using an electrostatic printer of the type generally disclosed in U.S. Pat. No. 6,167,225 to Sasald et al. Image density and background fog measurements were taken using a Gretag D186 Densitometer made by Gretag, Switzerland. Both the Comparison and Examples were imaged with and without a corona generating wire placed in a position adjacent to a liquid toner layer transport means, and applying a corona producing voltage to change the orientation of individual toner particles within the toner deposit prior to entering the development nip.

The results were as follows:

| | Image (ODU) | Background (ODU) |
|---|---|---|
| Comparison 1 | 1.19 | 0.10 |
| no charging | | |
| Comparison 1 | 1.42 | 0.01 |
| with charging | | |
| Example 1 | 1.43 | 0.00 |
| no charging | | |
| Example 1 | 1.45 | 0.00 |
| with charging | | |
| Example 2 | 1.39 | 0.00 |
| no charging | | |
| Example 2 | 1.41 | 0.00 |
| with charging | | |
| Example 3 | 1.35 | 0.01 |
| no charging | | |
| Example 3 | 1.35 | 0.00 |
| with charging | | |

The results illustrate that the novel marking liquid of the present invention achieves improved image quality without the need for any adjustment or change to the orientation of individual toner particles within the toner deposit prior to development of the electrostatic latent image. That is, the examples of the present invention illustrate that higher image optical density and reduced background fog or staining can be achieved without the need for the conditioning of the liquid toner layer prior to image development.

There has been hereto described a novel method of preparation of marking liquids exhibiting excellent imaging performance, including physical as well as electrical properties and stability. These novel marking liquids allow for the formation of an evenly orientated continuous toner layer for high development efficiency and superior image quality without the need for the use of a corona generating wire, a charging roller or the like, to adjust or change the orientation of individual toner particles within the toner deposit prior to the development of the latent electrostatic image.

It can be appreciated that changes to any of the above embodiments can be made without departing from the scope of the present invention and that other variations can be made by those skilled in the art without departing from the invention as defined in the appended claims.

1. A liquid toner or developer for electrostatic images characterised by a three phase colloid system comprising a carrier liquid in a carrier liquid phase, a marking particle in a marking particle phase and a dispersing agent in a dispersing agent phase wherein the marking particles are insoluble in the carrier liquid and the dispersing agent phase, and the dispersing agent comprises droplets which are non-compatible with the carrier liquid.

2. A liquid toner or developer as in claim 1 wherein the dispersing agent is selected from the group comprising amino-silicones, polymeric hyperdispersants, polymeric oil additives, polyolefins, and fluorinated surfactants and having regard for the carrier liquid to be used in a particular liquid developer or toner.

3. A liquid toner or developer as in claim 1 wherein the carrier liquid is selected from the group comprising isoparaffinic-hydrocarbons, a silicone fluid of straight chained configuration, a silicone fluid of cyclic configuration, a silicone fluid of branched configuration, or a combination thereof, a vegetable oil, soybean oil, cottonseed oil, safflower oil, sunflower oil, castor oil, linseed oil and olive oil, a synthetic oil, fatty acid esters obtained by the reaction between higher fatty acid and alcohol, and ester compounds obtained by the reaction between higher fatty acid and ethylene glycol or glycerine, a mineral oil or white oil and blends of the abovementioned carrier liquids.

4. A liquid toner or developer as in claim 1 wherein the dispersing agent is present in a range of 0.1 to 30% by weight of the toner.

5. A liquid toner or developer as in claim 1 wherein the carrier liquid comprises a light paraffin oil and the dispersing agent is an amino-silicone.

6. A liquid toner or developer as in claim 1 wherein the carrier liquid comprises a silicone fluid and the dispersing agent is selected from the group comprising polymeric oil additives, polyolefins, and fluorinated surfactants.

7. A liquid toner or developer as in claim 1 wherein the carrier liquid comprises a hydrocarbon and the dispersing agent is an amino-silicone.

8. A liquid toner or developer as in claim 1 wherein the insoluble marking particles comprise a colourant.

9. A liquid toner or developer as in claim 8 wherein the colourant is selected from the group comprising inorganic pigments such as iron oxide, silica, alumina, titanium dioxide, magnetic iron oxide, or organic pigments such as carbon black, phthalocyanine blue, alkali and reflex blue, phthalocyanine green, diarylide yellow, arylamide yellow, azo and diazo yellow, azo red, rubine toner, quinacridone red, basic dye complexes, lake red, or fluorescent pigments and dyestuffs such as basic dyes and spirit soluble dyes, or combinations thereof.

10. A liquid toner or developer as in claim 8 wherein the insoluble marking particles further comprise a resin or resin system.

11. A liquid toner or developer as in claim 10 wherein the resin or resin system is selected from the group comprising ethyl cellulose, oil modified alkyd resin, acrylic or methacrylic ester resin, polystyrene, silicone-acryl copolymer, silicone resin, silicone-(meth)acryl copolymer, block polymer or graft polymer, polyolefin copolymer, poly(vinyl chloride) resin, chlorinated polypropylene, polyamide resin, coumarone-indene resin, rosin-modified resin, and alkylphenol-modified xylene resin, synthetic polyesters; polypropylene or modified polypropylene; alkylated poly vinyl pyrrolidones; natural waxes such as montan wax, candelilla wax, sugar cane wax, beeswax, natural resins such as ester gum and hardened rosin; natural-resin-modified cured resins such as natural resin-modified maleic acid resins, natural resin-modified phenol resins, natural resin-modified polyester resins, natural resin-modified pentaerythritol resins, styrene acrylates and epoxy resins.

12. A liquid toner or developer as in claim 1 wherein the marking particle is present in the range of 1 to 60% by weight of the finished toner.

13. A liquid toner or developer as in claim 3 wherein the marking particle is present in the range of 1 to 60% by weight of the finished toner.

14. A liquid toner or developer as in claim 4 wherein the marking particle is present in the range of 1 to 60% by weight of the finished toner.

15. A liquid toner or developer as in claim 5 wherein the marking particle is present in the range of 1 to 60% by weight of the finished toner.

16. A liquid toner or developer as in claim 6 wherein the marking particle is present in the range of 1 to 60% by weight of the finished toner.

17. A liquid toner or developer as in claim 7 wherein the marking particle is present in the range of 1 to 60% by weight of the finished toner.

18. A liquid toner or developer as in claim 9 wherein the marking particle is present in the range of 1 to 60% by weight of the finished toner.

19. A liquid toner or developer as in claim 10 wherein the marking particle is present in the range of 1 to 60% by weight of the finished toner.

20. A liquid toner or developer as in claim 11 wherein the marking particle is present in the range of 1 to 60% by weight of the finished toner.
